(19) United States
(12) Patent Application Publication
(10) Pub. No.: US 2025/0103913 A1
(43) Pub. Date: Mar. 27, 2025

(54) ARTIFICIAL INTELLIGENCE PREDICTION SUPERVISION

(71) Applicant: INTERNATIONAL BUSINESS MACHINES CORPORATION, ARMONK, NY (US)

(72) Inventors: Courtney Branson, San Diego, CA (US); Aaron T. Smith, Raleigh, NC (US); Gabriel Idris Gilling, New York, NY (US); Rakshith Dasenahalli Lingaraju, Palo Alto, CA (US)

(21) Appl. No.: 18/473,217

(22) Filed: Sep. 23, 2023

(51) Int. Cl. G06N 5/022

(52) U.S. Cl. CPC G06N 5/022

(57) ABSTRACT

Automatic removal of AI bias associated with an AI model. A computing device accesses an AI model. The computing device executes two or more independent bias mitigation algorithms, each of the two or more independent bias mitigation algorithms designed to independently remove AI bias from the AI model. Results of execution of the two or more independent bias mitigation algorithms are displayed to the user. A selection is received from the user of one or more bias mitigation algorithms for use with the AI model. The selected one or more bias mitigation algorithms are executed to correct bias in the AI model.

### FIELD OF THE INVENTION

The present invention relates generally to artificial intelligence and more particularly to automated review and correction of predictions performed by artificial intelligence models.

### BACKGROUND

Presently disclosed embodiments relate to machine learning and, more generally, artificial intelligence. In 2023 artificial intelligence and machine learning are of increasing value to the public at large, with a diversity of applications including mortgage approvals, prison sentencing, financial analysis, online shopping, fraud prevention, and many others.

As individuals that work within the field understand, decisions made by artificial intelligence/machine learning models in these different areas may affect an individual's mortgage approval, prison sentence, etc. if it was determined even in part by a machine learning model. It is therefore crucial that decisions made by artificial intelligence/machine learning models be completely fair and free of bias. “Artificial intelligence bias” as discussed herein refers to systematic and repeatable errors in decisions of artificial intelligence/machine learning models which disproportionally effect one group over another in ways different from the intended function of the associated algorithm(s). De-biasing of AI models, however, is a complicated field even for experts in data science and the multitude of different approaches leads even the expert to not know where to begin.

A need presents itself for an accessible and effective manner of supervising decision making of artificial intelligence/machine learning models to particularly avoid artificial intelligence bias.

### SUMMARY

Embodiments of the present invention disclose a method, system, and computer program product to automatically remove AI bias associated with an AI model. A computing device accesses an AI model. The computing device executes two or more independent bias mitigation algorithms, each of the two or more independent bias mitigation algorithms designed to independently remove AI bias from the AI model. The computing device requests display to a user results of execution of the two or more independent bias mitigation algorithms. The computing device receives a selection from the user of one or more bias mitigation algorithms for use with the AI model. The computing device executes the selected one or more bias mitigation algorithms to correct bias in the AI model. In embodiments of the invention, each of the two or more independent bias mitigation algorithms is associated with exactly one bias mitigation strategy type of a plurality of available bias mitigation strategy types, including pre-processing mitigation, in-processing mitigation, and post-processing mitigation. Results of execution may include an independent effectiveness of each of the two or more independent bias mitigation algorithms. Embodiments of the invention execute in a machine learning pipeline.

In alternative aspect of the present invention, embodiments of the present invention disclose another method, system, and computer program product to remove AI bias associated with an AI model. The computing device accesses an AI model. The computing device executes two or more independent bias mitigation algorithms in a machine learning pipeline, a result of a first independent bias mitigation algorithm used as an input to a subsequent independent bias mitigation algorithm. The computing device requests display to a user a result of execution of the machine learning pipeline, the result of execution of machine learning pipeline including a scorecard summarizing results of removal of AI bias from the AI model. The computing device receives a selection from a user of one or more new independent bias mitigation algorithms to modify the machine learning pipeline. The computing device executes a modified machine learning pipeline based on the selection from the user; and display to the user an updated scorecard based on the modified machine learning pipeline. Each of the two or more independent bias mitigation algorithms is associated exactly one bias mitigation strategy type of a plurality of bias mitigation strategy types, including two or more of pre-processing mitigation, in-processing mitigation, and post-processing mitigation.

### BRIEF DESCRIPTION OF THE DRAWINGS

FIG. 1 represents a networked computer environment 100, in accordance with an embodiment of the present invention.

FIG. 2 is a functional block diagram illustrating modules for artificial intelligence prediction supervision 200, in accordance with an embodiment of the present invention.

FIG. 3 is a process flow diagram 300 illustrating operational steps that a hardware component, multiple hardware components, and/or a hardware appliance may execute, in accordance with an embodiment of the present invention.

FIG. 4 is a process flow diagram 400 illustrating alternative operational steps that a hardware component, multiple hardware components, and/or a hardware appliance may execute, in accordance with an embodiment of the present invention.

### DETAILED DESCRIPTION

The presently disclosed embodiments relate one or more methods, systems, and computer program products for artificial intelligence prediction supervision and removal of AI bias from decisions of artificial intelligence/machine learning (collectively referred to herein as “artificial intelligence” or “AI”) models. As the value of decision making of artificial intelligence models continues to increase in the 21^{st} century, it is increasingly necessary to make sure that the decisions are free of artificial intelligence bias. Since the mathematical calculations behind artificial intelligence decisions and bias reduction are very complicated, embodiments of the invention also present options to gauge bias as well as gauge bias reduction and automatically reduce AI bias in an automated machine learning environment allowing non-experts to easily view and manipulate AI models (such as with a machine learning pipeline).

Unfortunately, due to the complicated nature of AI models, even data scientists specializing in the field do know where to begin. Generally, AI bias reduction is performed in three different ways: via pre-processing mitigation, via in-processing mitigation, and via post-processing mitigation. Pre-processing mitigation is a strategy for AI bias reduction which focuses on making changes to a training data set used for training AI models in the first instance. Corrections to various aspects of training data result in a corrected model, once the model is trained. In-processing mitigation focuses on making in-process changes to the AI model with debiasing as its main goal. Post-processing mitigation focuses on changing a prediction of an AI model after the decision is made.

Any of these approaches may be effective in a given circumstance, but the choice of which approach to use may be beyond the grasp of even experts in the field of AI. Each of the mitigation strategies focuses on using unique algorithms designed to correct bias in an AI model but which strategy and associated algorithms to use is a very complicated problem. Embodiments of the invention present automated methods of rating AI bias in AI models, correcting AI bias in AI models, and other functionality with regard to AI models as discussed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved. the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as associated with modules for artificial intelligence prediction supervision 200. In addition to modules 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and modules 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

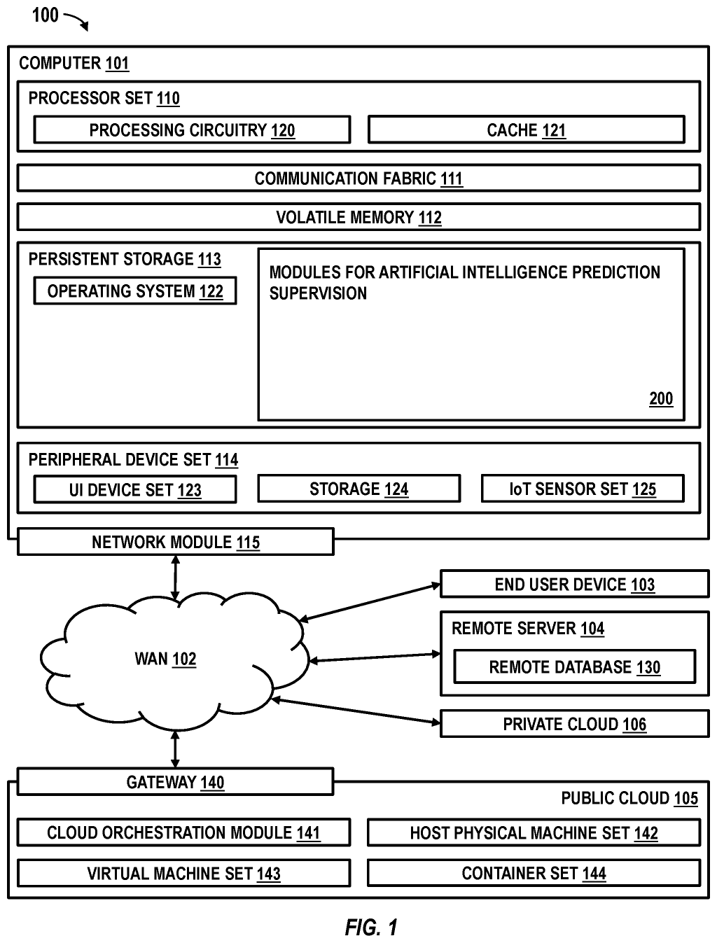

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processor set 110 may be alternatively be referred to herein as one or more “computing device(s),” but computing devices may also refer to one or more CPUs, microchips, integrated circuits, embedded systems, or the equivalent, presently existing or after-arising. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in modules 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in modules 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

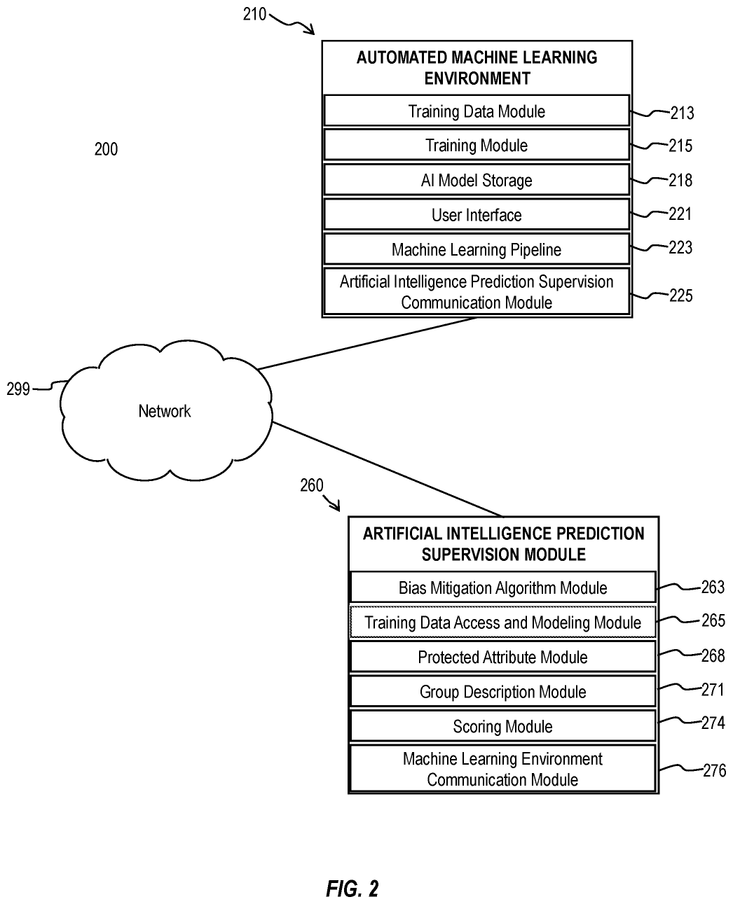

FIG. 2 is a functional block diagram illustrating modules for artificial intelligence prediction supervision 200, in accordance with an embodiment of the present invention. As an overview, FIG. 2 displays automated machine learning environment 210, artificial intelligence prediction supervision module 260, and network 299. In an embodiment of the invention, such as displayed in FIG. 2, automated machine learning environment 210 is operatively connected to artificial intelligence prediction supervision module 260 directly or via network 299. Automated machine learning environment 210 may be any sort of computer software (and, in various embodiments, associated computer hardware) for provided various automated functionality in connection with artificial intelligence models, including training, modifying, composing, selecting, parameterization and/or other functionality associated with artificial intelligence models. A user interface facilitates data scientists, analysts, developers, etc. to easily perform these functions with regard to one or more artificial intelligence models without direct manipulation of the AI model in source code form, direct manipulation of model weights, or otherwise. Instead, a user interface facilitates users manipulating AI models in a more convenient, accessible, and simple fashion. As those who work in the field of artificial intelligence understand, however, decisions or other output from AI models may be affected by AI bias (for various reasons, as discussed herein), which is reviewed and corrected by artificial intelligence prediction supervision module 260 in embodiments discussed herein.

Artificial intelligence prediction supervision module 260, also displayed in FIG. 2, is operatively connected to automated machine learning environment 210 directly or via network 299. Alternatively, artificial intelligence prediction supervision module 260 is integrated with automated machine learning environment 210, both execute as separate modules associated with automated machine learning environment 210, artificial intelligence prediction supervision module 260 executes via a plug-in to automated machine learning environment 210, access to/via a common web browser, or via other equivalent means. Generally, and as discussed further in connection with embodiments of the invention disclosed herein, artificial intelligence prediction supervision module 260 is responsible for accessing trained AI models associated with automated machine learning environment 210, detecting whether the AI models present a level of AI bias, presenting results of AI bias determinations to the user, and correcting the AI models if AI bias is present.

As further displayed in FIG. 2, in various embodiments of the invention, automated machine learning environment 210 and artificial intelligence prediction supervision module 260 are connected to and via network 299. In various embodiments, network 299 is substantially the same as WAN 120, discussed in connection with FIG. 1 herein. In general, network 299 may be any combination of connections and protocols that will support communications between automated machine learning environment 210 and artificial intelligence prediction supervision module 260, in accordance with embodiments of the invention. In further embodiments of the invention, network 299 may represent an internal bus associated with a single or multicore processor executing both automated machine learning environment 210 and artificial intelligence prediction supervision module 260 (such as in embodiments where automated machine learning environment 210 and artificial intelligence prediction supervision module 260 are integrated).

Discussing elements displayed in FIG. 2 in further detail, automated machine learning environment 210 represents computer software (and, in various embodiments, associated computer hardware) for providing individuals interested in artificial intelligence modeling (such as, for example, data scientists, analysts, developers, etc.), with provided various automated functionality to use in connection with artificial intelligence models, including training, modifying, composing, selecting, parameterization and/or other using artificial intelligence models. In various embodiments of the invention, automated machine learning environment 210 includes one or more of training data module 213, training module 215, AI model storage 218, user interface 221, machine learning pipeline 223, and artificial intelligence prediction supervision communication module 225.

Training data module 213 represents software and/or hardware for storing and making available a training dataset for training of AI models. AI models require a significant amount of “training data” (as from a training dataset) in order to “train” the models for utilization in making predictions. As one of skill in the art understands, AI models, in effect, look for patterns in data and then make predictions for new fact patterns based upon the discovered patterns. In training of AI models associated with neural networks, for example, different layers of a neural network with connections between “neurons” in the neural network are associated with different weights, gradients, etc. allowing for correct interpretations of new data (based upon the discovered patterns). Training data stored in training data module 213, however, may be “biased” and predictions/models made based upon biased data are therefore also biased. Embodiments of the invention disclosed may rely upon pre-processing mitigation as a bias mitigation strategy type in order to correct AI bias with changes to the training dataset (further discussed elsewhere herein). Training data stored by training data module 213 may be accessed and utilized by artificial intelligence prediction supervision module 260, in de-biasing AI models, as further discussed herein.

Training module 215 represents software and/or hardware for training of AI models. As discussed, after accessing training data stored in training data module 213, training module 215 trains AI models based upon the training data. AI models trained may be in nature supervised, unsupervised, or partially supervised, but all are contemplated for utilization in connection with embodiments of the invention. AI models may be specifically in the form of neural networks, decision trees, linear regression, support vector machines, etc. As training module 215 trains models with training data from training data module 213, “neurons” (or other nodes) in the relevant AI models are, in effect, linked in different ways via connections, weights, gradients, etc. to better interpret patterns in the training data. As discussed elsewhere herein, trained AI models, however, may display AI bias, which needs to be addressed by embodiments of the invention disclosed herein. Training of AI models by training module 215 may represent a large commitment in terms of processing time and system resources. Trained AI models trained by automated machine learning environment 210 are stored by AI model storage 218, as further discussed herein. AI models may also be re-trained by training module 215.

AI model storage 218 represents software and/or hardware for storing of trained AI models trained by training module 215. The trained AI models may be utilized in connection with other functionality associated with automated machine learning environment 210 (such as for making predictions or decisions), re-training by training module 215, de-biasing by artificial intelligence prediction supervision module 260, or in other ways.

User interface 221 represents software and/or hardware for a user of automated machine learning environment 210 (such as a data scientists, analysts, developers, etc.), to easily access and manipulate AI models associated with automated machine learning environment 210. User interface 221 may be, in embodiments of the invention, a graphical user interface, command line, or other computer interface allowing user to manipulate AI models stored by AI model storage 218. In embodiments of the invention, user interface 221 also presents various functionality for a user to determine whether bias exists in AI models, read “scorecards” associated with AI bias in AI models, provide access to functionality for automatically correcting AI bias in AI models, and provide other information and/or functionality as discussed further herein.

User interface 221 may, in various embodiments of the invention, also display to user results of execution of two or more bias mitigation algorithms (as discussed further in connection with artificial intelligence prediction supervision module 260). User interface 221, in embodiments of the invention, also presents functionality for a user to “select” one or more independent bias mitigation algorithms for finalized usage with the AI model, such as via alternative menus, a toggle switch, etc., in order to request that machine learning pipeline 223 execute the independent bias mitigation algorithms singly, alternatively, or sequentially.

Machine learning pipeline 223 represents software and/or hardware for performing various automated and requested functions associated with an entire lifecycle of AI models, including access of training data from training data module 213, request training of AI models by training module 215, re-training of AI models by training module 215, request inferences be made by AI models stored in AI model storage 218, and perform various functionality in assessing, scoring, and eliminating AI bias in connection with artificial intelligence prediction supervision module 260 while machine learning pipeline 223 is executing (as discussed further herein). In embodiments of the invention (as discussed further below), machine learning pipeline 223 operates in conjunction with bias mitigation algorithm module 263 to execute various independent bias mitigation algorithms designed to independently remove AI bias from AI models stored by AI model storage 218. Execution of various functionality associated with AI models in machine learning pipeline 223 provides for simple and streamlined performance of the various tasks associated with AI models (as discussed), greatly simplifying their use by a more ordinary user.

In an embodiment of the invention, machine learning pipeline 223 executes two or more independent bias mitigation algorithms in the machine learning pipeline in a sequential manner, where a result of a first independent bias mitigation algorithm is used as an input to a subsequent bias mitigation algorithm. Results of execution of machine learning pipeline 223 executing multiple independent bias mitigation algorithms in sequential manner are displayed to a user in a scorecard generated by scoring module 274 in user interface 221. Machine learning pipeline 223 (in conjunction with user interface 221) may then receive a selection from a user of one or more new independent bias mitigation to modify the machine learning pipeline of two or more independent bias mitigation algorithms, and then machine learning pipeline 223 executes a modified machine learning pipeline 223 based on the selection from the user.

Artificial intelligence prediction supervision communication module 225 represents software and/or hardware for communications between automated machine learning environment 210 and artificial intelligence prediction supervision module 260, including communication of various necessary training data, artificial intelligence model, decisions of trained artificial bias mitigation algorithms, results of de-biasing, etc. Artificial intelligence prediction supervision communication module 225 may represent a software interface and associated hardware, other software methods and associated hardware, or the presently existing or after-arising equivalent.

Continuing to discuss elements of FIG. 2 in further detail, artificial intelligence prediction supervision module 260 represents computer software (and, in various embodiments, associated computer hardware) for accessing trained AI models associated with automated machine learning environment 210, detecting whether the AI models present a level of AI bias, presenting results of AI bias determinations to the user, and correcting the AI models if AI bias is present. In various embodiments of the invention, artificial intelligence prediction supervision module 260 includes one or more of bias mitigation algorithm module 263, training data access and modeling module 265, protected attribute module 268, group description module 271, scoring module 274, and machine learning environment communication module 276.

Bias mitigation algorithm module 263 represents software and/or hardware for storage and execution of independent bias mitigation algorithms to independently remove AI bias from trained AI models stored by AI model storage. As discussed elsewhere herein, each independent bias mitigation algorithm includes is associated with exactly one bias mitigation strategy type of a plurality of bias mitigation strategy types, including pre-processing mitigation, in-processing mitigation, and/or post-processing mitigation. An example of a pre-processing mitigation algorithm which may be associated with bias mitigation algorithm module 263 is a disparate impact algorithm. An example of an in- processing algorithm which may be associated with bias mitigation algorithm module 263 is an adversarial debiasing algorithm. An example of a post-processing algorithm which may be associated with bias mitigation algorithm module 263 is reject option classification modeling. In various embodiments of the invention, other algorithms associated with these bias mitigation strategy types are utilized, while still being contemplated as within the scope of the invention. Bias mitigation strategy types may be utilized at different stages of the life of an AI model, or different stages within a machine learning pipeline. Each may be of varying effectiveness based upon the nature of the training data, the AI model, the requested inference of the AI model, etc. Every situation is unique, however, for the given situation pre-processing, in-processing, or post-processing may be the most effective. Embodiments of the invention disclosed herein assist in the determination of which strategy to use in each particular situation with each AI model.

Bias mitigation algorithm module 263 in conjunction with machine learning pipeline 223 accesses AI models stored by AI model storage 218 and executes independent bias mitigation algorithms to independently remove AI bias from AI models stored by AI model storage 218. Results of execution of the independent bias mitigation algorithms are requested by bias mitigation algorithm module 263 to be displayed to a user by user interface 221. In an embodiment of the invention, results of execution may include an independent effectiveness of each of the two or more independent bias mitigation algorithms, including, for example, a minimum accuracy impact or a maximum fairness impact. The minimum accuracy impact or maximum fairness impact are displayed, in various embodiments of the invention, in accessible, numerical ways, such as via a chart on user interface 221. Independent effectiveness (such accuracy/fairness impact) is provided to allow a user to decide which AI model to use in easiest way possible. In further embodiments of the invention, independent bias mitigation algorithms associated with bias mitigation algorithm module 263 are executed in a sequential manner, where a result of a first bias mitigation algorithm is used as an input to one or more subsequent bias mitigation algorithms in machine learning pipeline 223.

Bias mitigation algorithm module 263 in conjunction with user interface 221, in embodiments of the invention, also presents functionality for a user to “select” one or more independent bias mitigation algorithms for finalized usage with the AI model, and to execute the selected one or more bias mitigation algorithms to correct bias in the AI model (in conjunction with the machine learning pipeline 223).

Training data access and modeling module 265 represents software and/or hardware for access and utilization of training data stored by training data module 213 in various ways. Training data may be utilized in connection with pre-processing mitigation (utilizing independent bias algorithms as discussed elsewhere herein) or with initial fairness metric determinations regarding protected attributes in training data. In connection with initial fairness metric determinations, training data access and modeling module 265 accesses training data used to train AI models stored by training data module 213. Training data access and modeling module 265 profiles one or more protected attributes available from the training data module 213, such as by generating a statistical distribution of the one or more protected attributes, which is used to find correlations between protected attributes and non-protected attributes, and the correlations are, in turn, used to generate an initial fairness metric on each protected attribute or identify attributes in the training data that lead to indirect bias (such as when the value of a protected attribute is correlated with the value of another attribute). The initial fairness metric may be provided to the user via user interface 221, in order to initially assess whether bias is present in an AI model or associated training data. Protected attributes, as discussed further below, in embodiments of the invention are selected by the user in connection with protected attribute module 268. In embodiments of the invention. (particularly those involving pre-processing mitigation of bias in an AI model) access to training data is an important step, since if there is bias in the training data, bias may thereafter be present in the trained AI model. Pre-processing mitigation or other tactics involving training data are effective techniques in de-biasing AI models. Profiling of protected attributes, statistical reviews of training data, correlating protected and non-protected attributes in training data, and other identification of attributes in the training data all may be utilized in de-biasing AI models, gaining typical advantages associated with de-biasing AI models.

Protected attribute module 268 represents software and/or hardware for performing various functionality in connection with one or more “protected attributes” utilized in various ways as discussed herein. In an embodiment of the invention, protected attribute module 268 accepts selections of one or more protected attributes made from a user via user interface 221 (of all the categories of “attributes” within training data available from training data module 215). Easy selection of protected attributes by a user, such as via user interface 221 provides for a simple and streamlined means for users to choose exactly “how” to de-bias AI models, avoiding unnecessary technical complexity. The protected attributes selected by user are utilized in various ways, in connection with embodiments of the invention, as in connection with generation of an initial fairness metric (as discussed in connection with training data access and modeling module 265).

Group description module 271 represents software and/or hardware for accepting of a group description of privileged and unprivileged groups from user via user interface 221. The privileged and unprivileged group descriptions received from user are used by group description module 271 to determine whether bias exists in the AI model(s) stored by AI model storage 218 (specifically, with regard to the groups identified). Easy selection of group descriptions by a user such as via user interface 221 provides for a simple and streamlined means for users to choose exactly “how” to de-bias AI models, avoiding unnecessary technical complexity. If bias does exist in AI model storage 218, group description module 271 in conjunction with user interface 221 displays the bias associated with the groups identified via user interface 221.

Scoring module 274 represents software and/or hardware for generation and display of various “scores,” “scorecards,” and/or “grades” associated with the various aspects of AI bias and bias mitigation efforts (as discussed herein). The “scores,” “scorecards,” and/or “grades” in an embodiment of the invention, may be displayed to user via user interface 221. For example, after execution of two or more independent bias mitigation algorithms by bias mitigation algorithm module 263, scoring module 274 may generate a “scorecard” summarizing results of removal of AI bias from the AI model including, for example, a difference in a biased attribute after execution of each independent bias mitigation algorithm, as well as an effect on AI model accuracy and baseline results. Generally, the scorecard(s) are used to allow a user to see which bias mitigation algorithm is the most effective in an easy-to-view manner. The scorecard may be based on any performance metric used to measure a success of removal of bias from the AI model. The performance metric utilized provides an easy manner for the user to see the results of execution. In various embodiments of the invention, for example, the scorecard may display a “grade” such as A, B, C, D, or F for success of removal of bias from the AI model. In embodiments two or more independent bias mitigation algorithms are associated with exactly one bias mitigation strategy type of a plurality of bias mitigation strategy types, the scorecard reflects which bias mitigation strategy type is associated with grade of a plurality of grades in the scorecard (i.e., independent bias mitigation algorithm 1 received a B, independent bias mitigation algorithm 2 received an A, independent bias mitigation algorithm C received an F). In embodiments of the invention where multiple independent bias mitigation algorithms are executed sequentially in machine learning pipeline 223, scoring module 274 generates a scorecard summarizing results of execution of the multiple independent bias mitigation algorithms, and the generated scorecard is displayed to the user via user interface 221 (to provide the user an easy way to view the score). An updated scorecard may also be generated by scoring module 274 which displays further results of execution of other independent bias mitigation algorithms selected by the user in user interface 221 and executed by machine learning pipeline 223.

Machine learning environment communication module 276 represents software and/or hardware for all necessary communications between automated machine learning environment 210 and artificial intelligence prediction supervision module 260, including all data, requests, responses, etc. necessary for execution of embodiments of the invention disclosed herein.

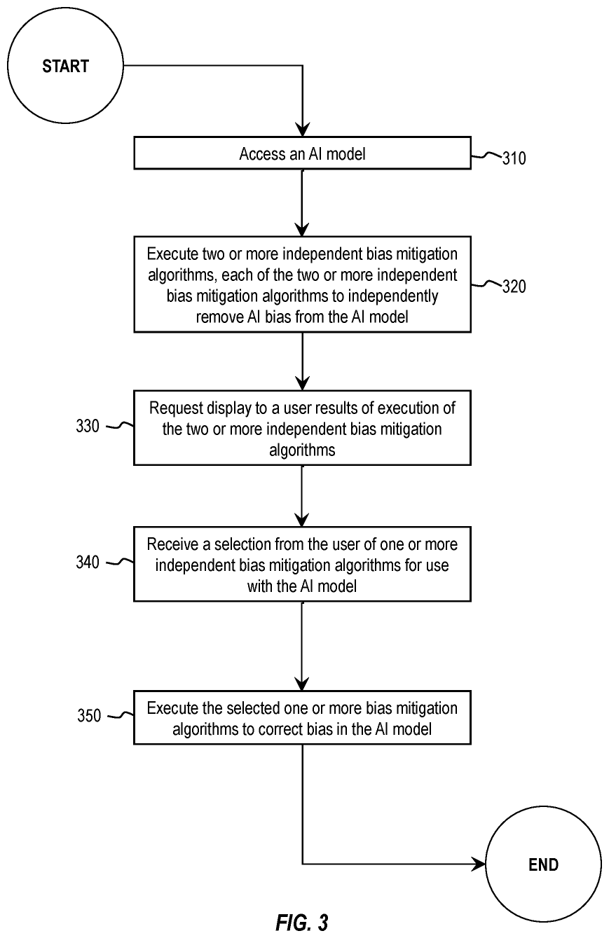

FIG. 3 is a flowchart depicting operational steps that a hardware component, multiple hardware components, and/or a hardware appliance may execute, in accordance with an embodiment of the invention. As shown in FIG. 3, at step 310, bias mitigation algorithm module 263 accesses an AI model stored by AI model storage 218. At step 320 bias mitigation algorithm module 263 executes independent bias mitigation algorithms to independently remove AI bias from AI models stored by AI model storage 218. At step 330 bias mitigation algorithm module 263 requests display by user interface 221 of results of execution of the two or more independent bias mitigation algorithms (such as via a scorecard generated by scoring module 274). At step 340 bias mitigation algorithm module 263 receives a selection from the user made on user interface 221 of one of more bias mitigation algorithms for use with the AI model. At step 350 bias mitigation algorithm module 263 executes via machine learning pipeline 223 of the selected one or more bias mitigation algorithms to correct bias in the AI model. An embodiment of the invention such as displayed in connection with FIG. 3 provides for a user capabilities to automatically view potential results of one or more independent bias mitigation algorithms, and select one for automatic execution (presenting time savings as well as reducing the complexity associated with de-biasing AI models).

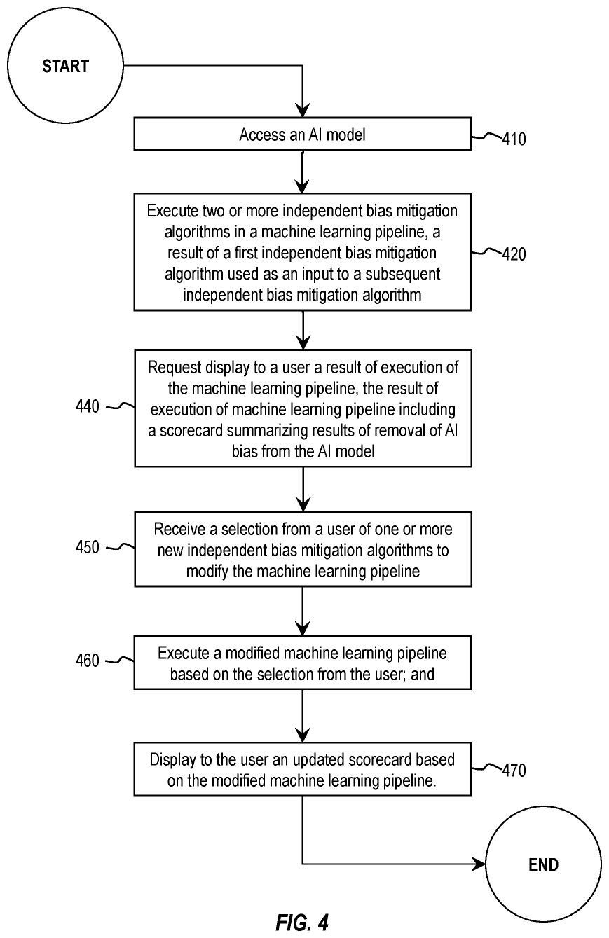

FIG. 4 is a flowchart depicting alternate operational steps that a hardware component, multiple hardware components, and/or a hardware appliance may execute, in accordance with an embodiment of the invention. As shown in FIG. 4, at step 410, bias mitigation algorithm module 263 accesses an AI model stored by AI model storage 218. At step 420, bias mitigation algorithm module 263 executes two or more independent bias mitigation algorithms in machine learning pipeline 223, a result of the first bias mitigation algorithm used as an input to a subsequent independent bias mitigation algorithm. At step 440, bias mitigation algorithm module 263 requests display by user interface 221 of results of execution of the machine learning pipeline 223, the results of execution including a scorecard (generated by scoring module 274) summarizing results of AI bias from the AI model. At step 450, bias mitigation algorithm module 263 receives a selection from a user via user interface 221 of one or more new independent bias mitigation algorithms to modify the machine learning pipeline 223. At step 460 bias mitigation algorithm module 263 executes a modified machine learning pipeline 223 based on the selection from the user of one or more new independent bias mitigation algorithms. At step 470, bias mitigation algorithm module 263 in conjunction with user interface 221 and displays an updated scorecard (generated by scoring module 274) based upon modified machine learning pipeline 223. An embodiment of the invention such as displayed in connection with FIG. 4 provides user capabilities to automatically execute multiple independent bias mitigation algorithms in a machine learning pipeline in order to further de-bias AI models in a user-friendly and effective manner. AI models are mathematically complex and unwieldy, and the automated functionality such as presented in FIG. 4 presents the opportunity to allow any user to de-bias AI models.

Based on the foregoing, a method, system, and computer program product have been disclosed. However, numerous modifications and substitutions can be made without deviating from the scope of the present invention. Therefore, the present invention has been disclosed by way of example and not limitation.

What is claimed is:

1. A method using a computing device to automatically remove AI bias associated with an Al model, the method comprising:
accessing by a computing device an AI model;
executing by the computing device two or more independent bias mitigation algorithms, each of the two or more independent bias mitigation algorithms designed to independently remove AI bias from the AI model;
requesting display to a user results of execution of the two or more independent bias mitigation algorithms;
receiving a selection from the user of one or more bias mitigation algorithms for use with the AI model; and
executing the selected one or more bias mitigation algorithms to correct bias in the Al model.

2. The method of claim 1, wherein each of the two or more independent bias mitigation algorithms is associated with exactly one bias mitigation strategy type of a plurality of available bias mitigation strategy types.

3. The method of claim 2, wherein the available bias mitigation strategy types include pre-processing mitigation, in-processing mitigation, and post-processing mitigation.

4. The method of claim 1, further comprising accessing by the computing device training data used to train the AI model.

5. The method of claim 4, further comprising profiling by the computing device one or more protected attributes in the training data.

6. The method of claim 5, wherein profiling by the computing device one or more protected attributes in the training data includes generating a statistical distribution of training data.

7. The method of claim 6, wherein the statistical distribution of training data is used to find a correlation between protected attributes and non-protected attributes, and the correlation is used to identify attributes in the training data that lead to indirect bias.

8. The method of claim 1, further comprising determining whether bias exists in the AI model via utilization of one or more protected attributes selected by a user via a computer interface.

9. The method of claim 1, further comprising determining whether bias exists in the AI model via utilization of one or more privileged or unprivileged group descriptions selected by the user via the computer interface.

10. The method of claim 1, wherein the computing device is executing a machine learning pipeline.

11. The method of claim 1, wherein the results of execution of the two or more independent bias mitigation algorithms include an independent effectiveness of each of the two or more independent bias mitigation algorithms.

12. The method of claim 11, wherein the independent effectiveness of the two or more independent bias mitigation algorithms is associated with a minimum accuracy impact or a maximum fairness impact.

13. The method of claim 1, further comprising after executing the selected one or more bias mitigation algorithms, generating and displaying a scorecard summarizing results of removal of AI bias from the AI model and displaying baseline results.

14. The method of claim 13, wherein the scorecard is based on a performance metric, the performance metric used to measure success of removal of bias from the AI model.

15. The method of claim 13, wherein the performance metric is displayed to the user via the computer interface.

16. The method of claim 13, wherein the selected one or more bias mitigation algorithms are associated with exactly one bias mitigation strategy type of a plurality of bias mitigation strategy types and the scorecard reflects which bias mitigation strategy type is associated with each grade of a plurality of grades in the scorecard.

17. A method using a computing device to remove AI bias associated with an AI model, the method comprising:
accessing by a computing device an AI model;
executing by the computing device two or more independent bias mitigation algorithms in a machine learning pipeline, a result of a first independent bias mitigation algorithm used as an input to a subsequent independent bias mitigation algorithm;
requesting display to a user a result of execution of the machine learning pipeline, the result of execution of machine learning pipeline including a scorecard summarizing results of removal of AI bias from the AI model;
receiving a selection from a user of one or more new independent bias mitigation algorithms to modify the machine learning pipeline;
executing by the computing device a modified machine learning pipeline based on the selection from the user; and
displayed to the user an updated scorecard based on the modified machine learning pipeline.

18. The method of claim 17, wherein each of the two or more independent bias mitigation algorithms is associated with exactly one bias mitigation strategy type of a plurality of bias mitigation strategy types.

19. The method of claim 1, wherein the plurality of bias mitigation strategy types includes selectively two or more of the following: pre-processing mitigation, in-processing mitigation, and post-processing mitigation.

20. A computer system to automatically remove AI bias associated with an AI model, the computer system comprising:
one or more computer processors;
one or more computer-readable storage media;
program instructions stored on the computer-readable storage media for execution by at least one of the one or more processors, the program instructions comprising:
program instructions to access an AI model;
program instructions to execute two or more independent bias mitigation algorithms, each of the two or more independent bias mitigation algorithms designed to independently remove AI bias from the AI model;
program instructions to request display to a user results of execution of the two or more independent bias mitigation algorithms;
program instructions to receive a selection from the user of one or more bias mitigation algorithms for use with the AI model; and
program instructions execute the selected one or more bias mitigation algorithms to correct bias in the AI model.
